(19) United States
(12) Patent Application Publication
(10) Pub. No.: US 2024/0068697 A1
(43) Pub. Date: Feb. 29, 2024

(54) THERMAL MANAGEMENT OF ACTIVELY COOLED TOTES USED IN LAST MILE DELIVERY OF FOOD

(71) Applicant: Phononic, Inc., Durham, NC (US)

(72) Inventors: Abhishek Yadav, Cary, NC (US); Ed Karwacki, Garner, NC (US); Michael Canaday, Durham, NC (US); Matt Taylor, Durham, NC (US); Sheldon Muir, Durham, NC (US); Mattias K-O Olsson, Durham, NC (US); Michael Hash, Raleigh, NC (US)

(21) Appl. No.: 18/240,922

(22) Filed: Aug. 31, 2023

Related U.S. Application Data
(60) Provisional application No. 63/402,862, filed on Aug. 31, 2022.
(60) Provisional application No. 63/429,764, filed on Dec. 2, 2022.
(60) Provisional application No. 63/443,160, filed on Feb. 3, 2023.

(51) Int. Cl. F24F 11/81; F24F 11/46; F24F 11/74; F24F 13/14

(52) U.S. Cl. CPC F24F 11/81; F24F 11/46; F24F 11/74; F24F 13/1426

(57) ABSTRACT

Systems and methods for thermal management are provided. In some embodiments, a vehicle for transporting one or more actively cooled totes, the vehicle includes: a central heat reject subsystem operable to reject heat from the one or more actively cooled totes; and an attachment mechanism for moving heat from the one or more actively cooled totes to the central heat reject subsystem.

### RELATED APPLICATIONS

This application claims the benefit of provisional patent application Ser. No. 63/402,862, filed Aug. 31, 2022; 63/429,764, filed Dec. 2, 2022; and 63/443,160, filed Feb. 3, 2023; the disclosures of which are hereby incorporated herein by reference in their entireties.

### FIELD OF THE DISCLOSURE

The disclosure relates generally to temperature-controlled environments.

### BACKGROUND

Cold chain transport for food, drug or any products that need temperature control for delivery currently is done with tri temperature or refer trucks and vans upfitted with compressor based systems that cool or freeze the entire sectioned area of a truck and must be run constantly to maintain temperature inside the truck weather the truck has one gallon of mike or a pint of ice cream you need to cool or freeze the entire space. Compressor based refer trucks and tri temp trucks or van must be penetrated from the outside to get the cooling platform of a compressor-based system inside the truck or van voiding the warranty of the van or truck. In addition, to run try temperature trucks you must use dividers between the temperature zones to maintain temperature. The separation of space requires you to separate orders that have goods in two or more zones. Compressor based systems pull too much power for the system to be placed in or on a fully electric vehicle without degrading the range of the vehicle significantly

Improved systems and methods for thermal management are needed.

### SUMMARY

Systems and methods for thermal management are provided. In some embodiments, a vehicle for transporting one or more actively cooled totes, the vehicle includes: a central heat reject subsystem operable to reject heat from the one or more actively cooled totes; and an attachment mechanism for moving heat from the one or more actively cooled totes to the central heat reject subsystem.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIGS. 1A-1D illustrate utilization of a portable, self-contained, refrigeration or freezing system, coupled with integrated automated controls and monitoring;

FIG. 2 and FIGS. 3A and 3B illustrate an example embodiment of an active cooler in accordance with embodiments of the present disclosure;

FIG. 4 illustrates a system including an active cooler in accordance with some embodiments of the present disclosure;

FIG. 5 illustrates an example of a tote as discussed herein;

FIG. 6 illustrates that different versions of the totes could be used in refrigerator or freezer versions;

FIG. 7 shows an exploded view of the tote that includes a thermoelectric unit as discussed herein;

FIG. 8 shows the standard tri-temperature truck that is used for deliveries;

FIG. 9 illustrates a delivery truck which does not need refrigeration systems or needs less refrigeration;

FIG. 10 and FIG. 11 illustrate various ways that vent ducting can be integrated into a tote rack;

FIG. 12 illustrates a circuit wire diagram for some embodiments;

FIG. 13 includes a logic table for controlling the various totes;

FIG. 14 illustrates a Racking system and Tote placement according to some embodiments;

FIG. 15 illustrates a single truck and the two zones created using traditional compressor cooling and transport processes;

FIG. 16 illustrates an example use of the disclosed totes for muti temp cold chain transport;

FIG. 17 illustrates that using “on demand” cooling can save energy and extend the range of the vehicle;

FIG. 18 illustrates an ability to place a customer's entire order of all temperatures on one shelf or section of the truck;

FIG. 19 illustrates a tote liner can be placed into the tote to help transport items in and out of the van in addition to the ability to move the totes in and out of the van with each order; and

FIG. 20 illustrates an example of upfitting an existing refrigerated truck to tri-temp or multi-temp truck.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Cold chain transport for food, drug or any products that need temperature control for delivery currently is done with tri temperature or refer trucks and vans upfitted with compressor based systems that cool or freeze the entire sectioned area of a truck and must be run constantly to maintain temperature inside the truck weather the truck has one gallon of mike or a pint of ice cream you need to cool or freeze the entire space. Compressor based refer trucks and tri temp trucks or van must be penetrated from the outside to get the cooling platform of a compressor-based system inside the truck or van voiding the warranty of the van or truck. In addition, to run try temperature trucks you must use dividers between the temperature zones to maintain temperature. The separation of space requires you to separate orders that have goods in two or more zones. Compressor based systems pull too much power for the system to be placed in or on a fully electric vehicle without degrading the range of the vehicle significantly.

The alternative to compressor-based cooling is to use passive cooling products like gel packs or dry ice to cool products packaged inside of boxes or totes, this is a very costly process in both labor and materials. Both the use of compressor and passive cooling and freezing is very damaging to the environment because of the refrigerant, the materials or the continuous running of the truck and compressor to maintain temperature.

Upfitting the transport vehicle with thermal electric active cooling and freezing totes with on demand cooling and sustainable refrigerants that require no penetration to the van/truck and minimal impact to range on electric vehicles.

The ability to use mobile and transportable containers using thermal electric cooling to be placed in transportation vehicles (e.g., van, box truck, car, train, plane, boat) would include the ability to use the same containers to transport between physical centers like MFC, stores and the mobile vehicle all the way to the house, apartment, or place of business. This would also include all IOT capabilities for command, control, and monitoring of the temperature of each container is transport. In some embodiments, this is used in an EV or combustion engine vehicles and using the power source of the vehicle and or a battery pack that would be recharged by the vehicle to power our totes.

Last mile delivery of food requires temperature-controlled transport of perishable food items using transit vans or similar vehicles. For temperature control, refrigerated or freezer totes can be used which are installed in the van (e.g., a cargo van) or a box truck.

These totes use an active heat pump to pull heat from an enclosed chamber and reject it to the surrounding ambient environment. When this is in an enclosed location such as a delivery van, the hot air can be removed from the van to improve operational performance of the totes.

These totes require power while in transit maintain food safety requirements for perishable consumption. The electrical system needed to reach (and/or maintain) the correct temperature should meet certain expectations for the operation of the totes.

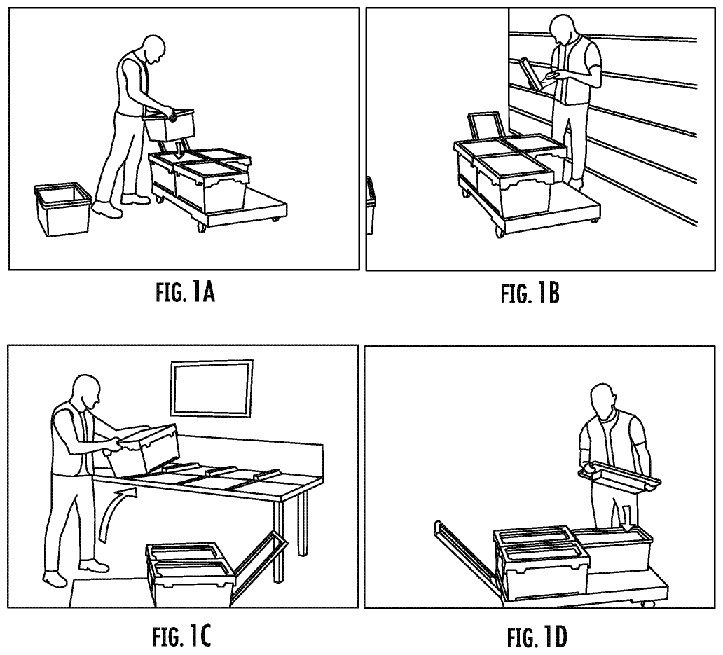

FIGS. 1A-1D illustrate utilization of a portable, self-contained, refrigeration or freezing system, coupled with integrated automated controls and monitoring.

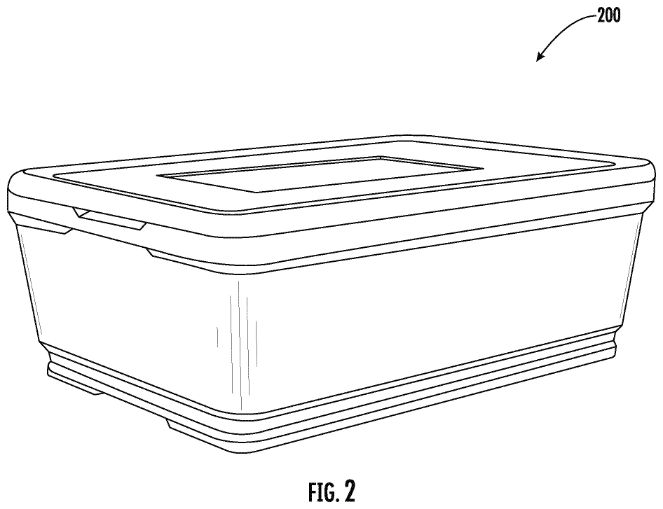

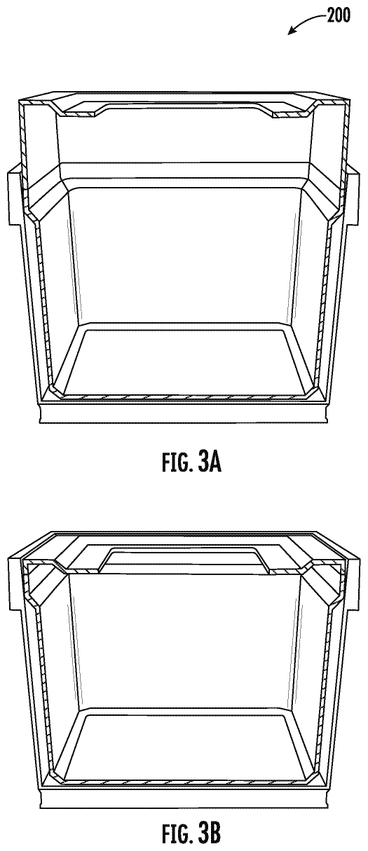

FIG. 2 and FIGS. 3A and 3B illustrate an example embodiment of an active cooler in accordance with embodiments of the present disclosure.

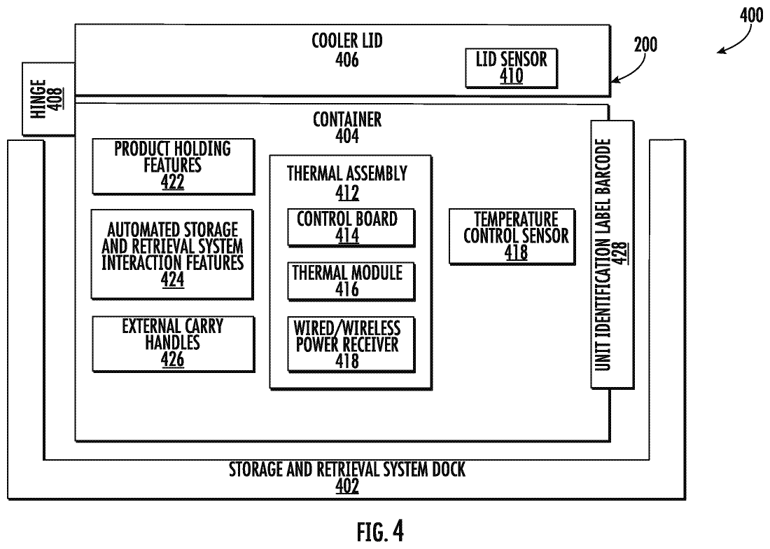

FIG. 4 illustrates a system including an active cooler in accordance with some embodiments of the present disclosure.

For more details, the interested reader is directed to U.S. Provisional Patent Application Ser. No. 62/953,771, entitled THERMOELECTRIC REFRIGERATED/FROZEN PRODUCT STORAGE AND TRANSPORTATION COOLER; U.S. patent application Ser. No. 17/135,420, entitled THERMOELECTRIC REFRIGERATED/FROZEN PRODUCT STORAGE AND TRANSPORTATION COOLER, now U.S. Patent Application Publication No. 2021/0199353 A1; and International Patent Application No. PCT/US2020/067172, entitled THERMOELECTRIC REFRIGERATED/FROZEN PRODUCT STORAGE AND TRANSPORTATION COOLER, now International Patent Publication No. WO 2021/134068. These applications are hereby incorporated herein by reference in their entirety.

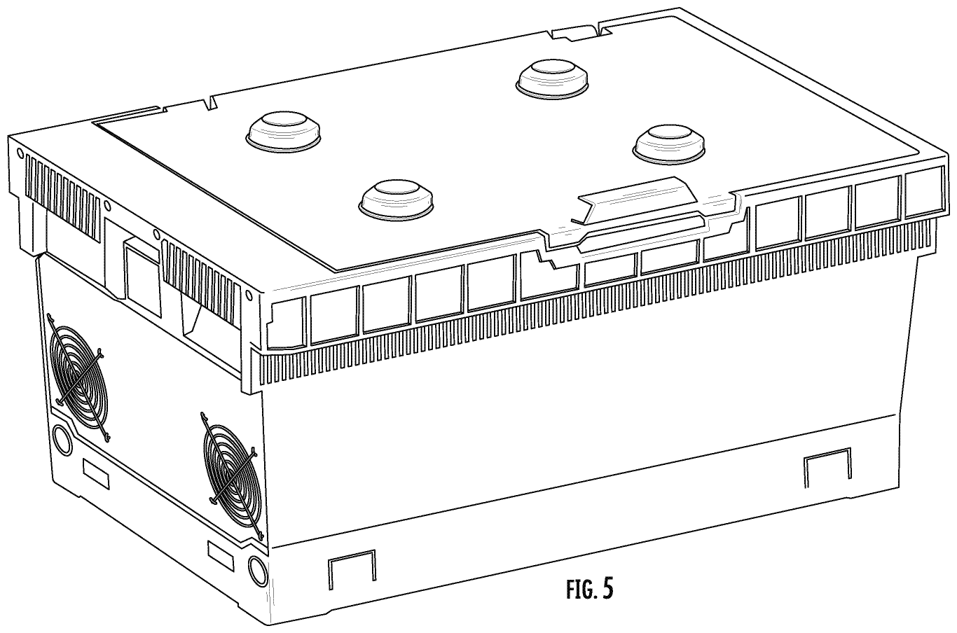

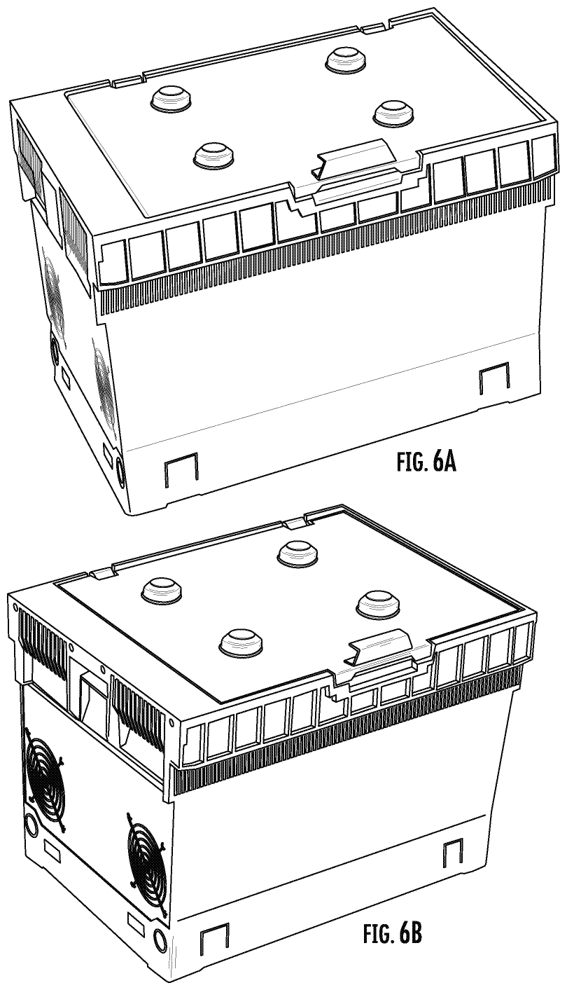

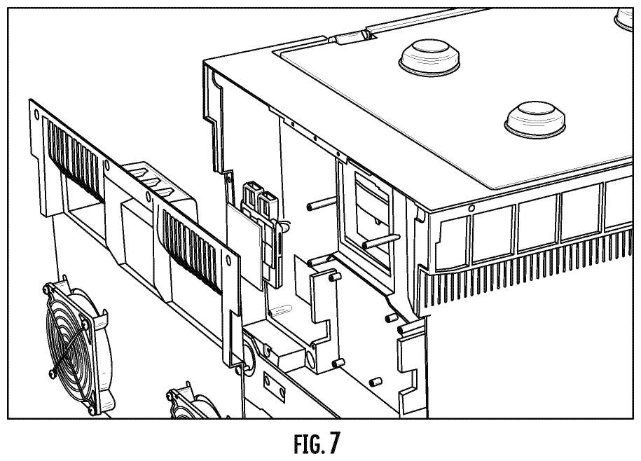

FIG. 5 illustrates an example of a tote as discussed herein. FIG. 6 illustrates that different versions of the totes could be used in refrigerator or freezer versions. FIG. 7 shows an exploded view of the tote that includes a thermoelectric unit as discussed herein.

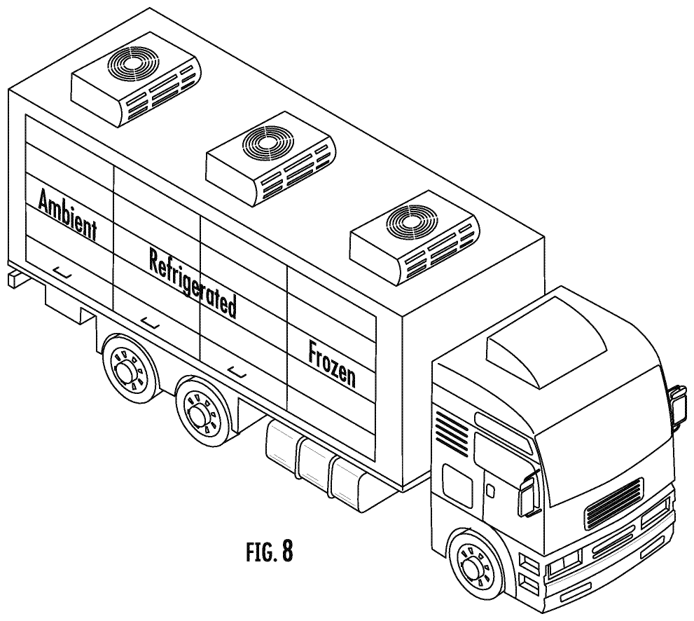

FIG. 8 shows the standard tri-temperature truck that is used for deliveries. This might include several different cooling systems that must be carried around regardless of whether they are currently needed.

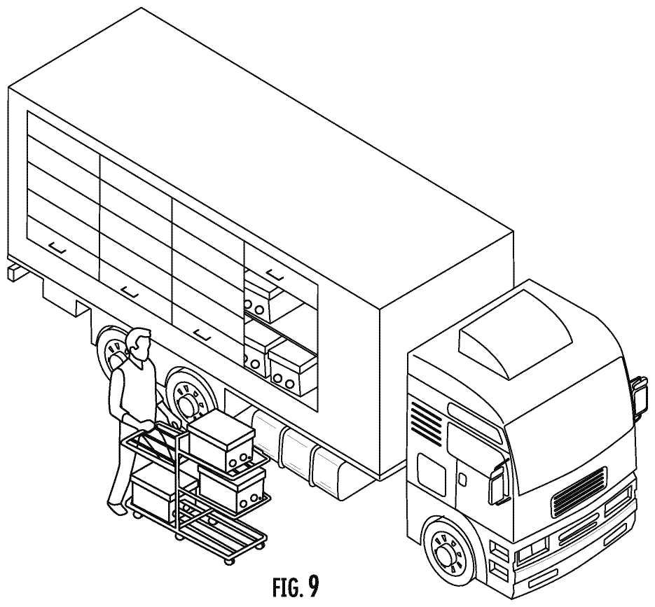

FIG. 9 illustrates a delivery truck which does not need refrigeration systems or needs less refrigeration. In this embodiment, the totes provide the proper temperatures for the various goods. This can make the trucks more efficient in many ways. This also adds configurability. If an entire truck is needed for a specific temperature, this can be easily accomplished as opposed to the standard truck. These trucks might include charging capabilities or other amenities.

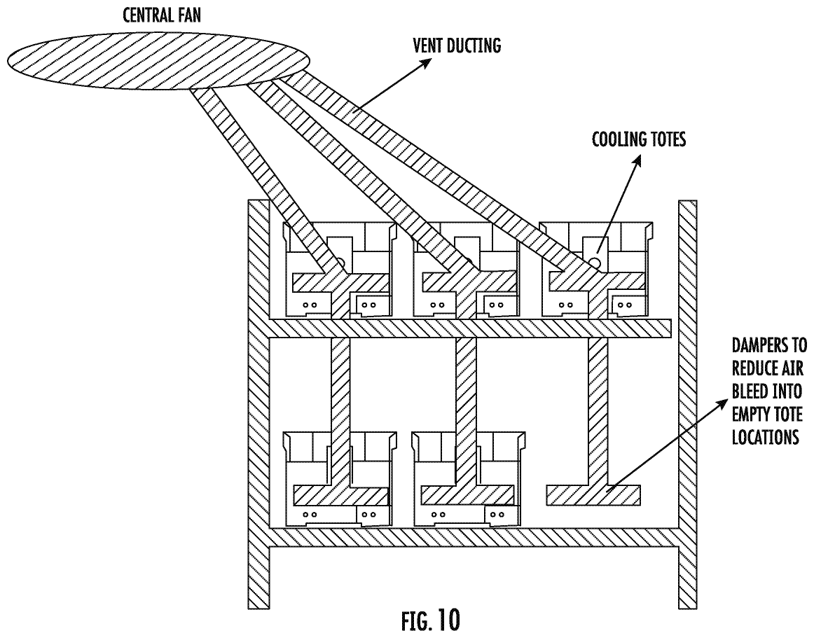

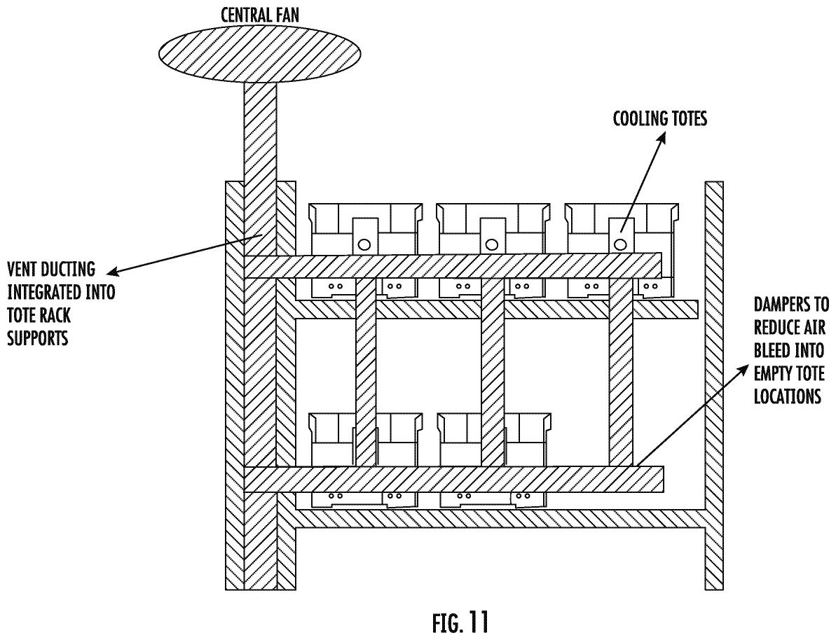

FIG. 10 and FIG. 11 illustrate various ways that vent ducting can be integrated into a tote rack. Additional heat from totes can be removed by actively ducting the hot reject air to the outside environment. A central vent fan will provide airflow to outside. Individual totes can be connected to it using flexible ducting. The connection can involve a spring-loaded mechanism to push the tote against a compressible gasket and seal the duct to the exhaust of the tote. A damper can be used to reduce air from moving back into the van when a tote location is not occupied.

The ducting can also be integrated into the support structure of racking to reduce the space occupied by ducting. The support beams for racking can be made hollow and ducting can be through these hollow channels.

To further improve air exchange from outside, vents can be included in the side of the van to improve air inlet from outside. These vents can be angled to increase the amount of air coming in as the van gains speed. Additional venting can be included in the back to enhance turbulence and air mixing inside the van.

Another method to remove the heat from the tote is to use a liquid cooling loop. The tote reject heat exchanger can be made of a flat plate mated to a liquid cold plate which stays stationary in the van. The liquid can be cooled using a radiator or a refrigerant chiller loop.

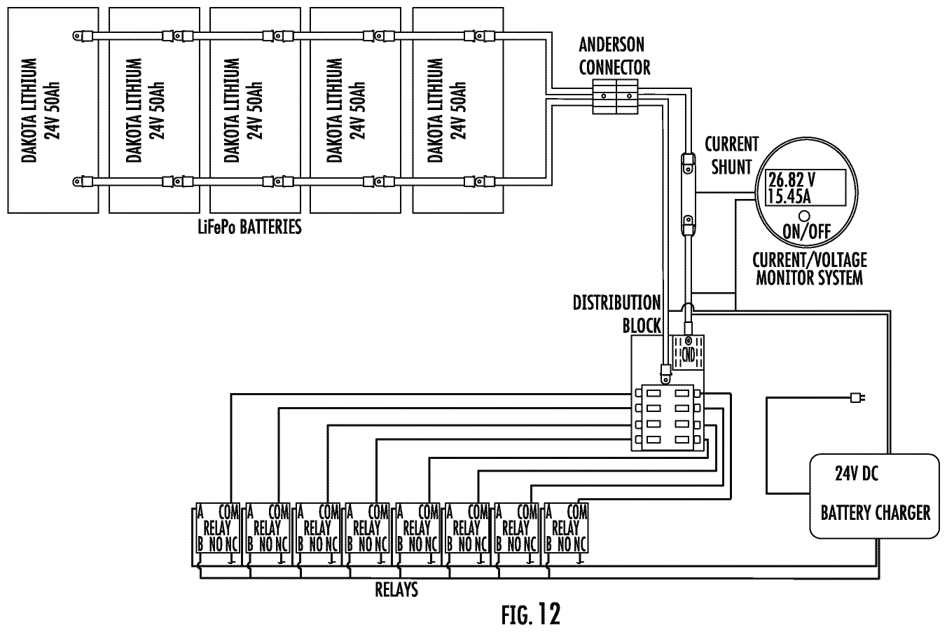

FIG. 12 illustrates a circuit wire diagram for some embodiments. Multiple batteries are shown in parallel with a connector (e.g., an Anderson Connector) to the rest of the circuit. Between the batteries and the Distribution Block there is a Current Shunt connected to a Current/Voltage Monitoring System. The system also includes multiple relays and a battery charger.

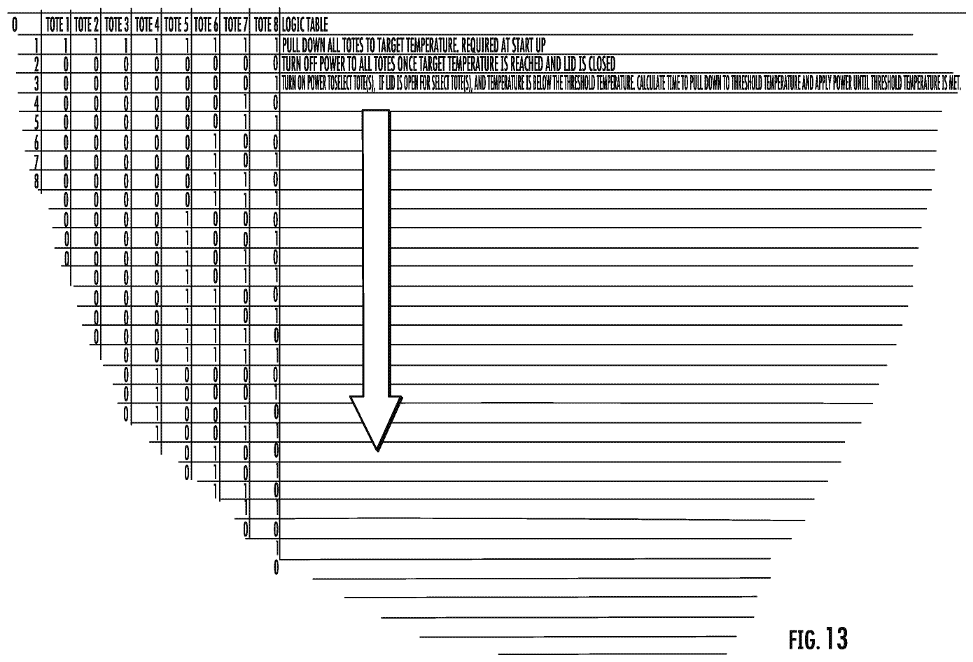

FIG. 13 includes a logic table for controlling the various totes. An example is shown with eight totes. The first row shows the case: Pull down all totes to target temperatures. Required at start up. The next row shows: Turn off power to all totes once target temperate is reached and lid is closed. The third row shows: Turn on power to select tote(s), if Lid is open for select Tote(s), and temperature is below the threshold temperature. Calculate time to pull down to threshold temperature and apply power until threshold temperature is met.

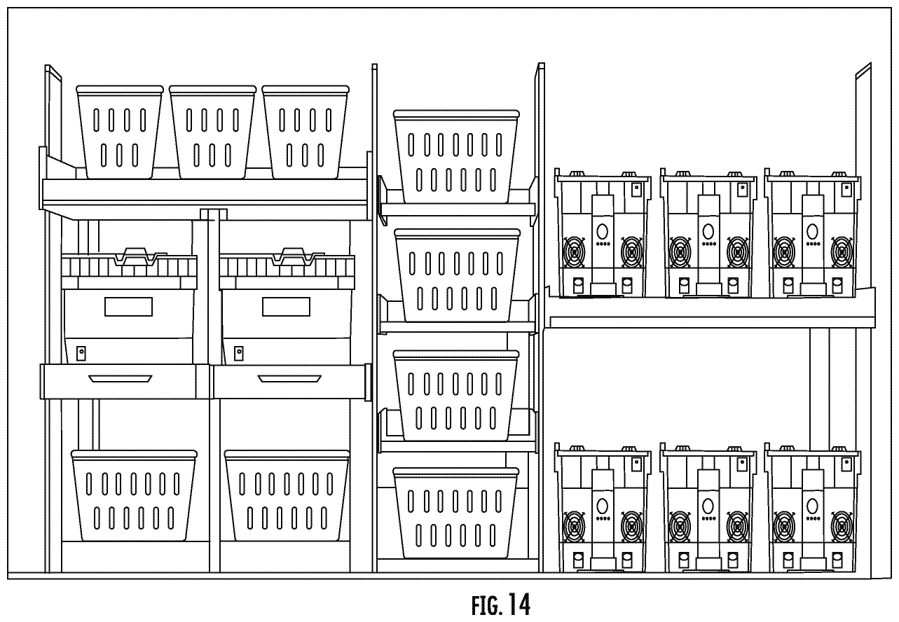

FIG. 14 illustrates a Racking system and Tote placement according to some embodiments.

In some embodiments, the electrical distribution includes multiple rechargeable lithium-ion batteries sized to meet the power requirements of the multiple thermal electric Tote, power cables sized for the power rating, power connectors, a shunt, a power distribution block with a polarity of connection points, a current and voltage monitoring system, polarity of relays, and/or an active thermal electric Tote.

In some embodiments, the electrical distribution includes a heating system that monitors battery temperature and provides heat to the batteries to improve proper use in cold environments.

In some embodiments, the electrical distribution includes an insulated material to trap heat during use and allow for higher ambient differentiated temperatures in the select area for the battery placement when not in use.

In some embodiments, the electrical distribution includes a heating element and/or fan that is placed properly in relation to the battery system and, where a current is suppled through the heating element to maintain a circulated air of a higher differential ambient temperature.

In some embodiments, the electrical distribution includes a processor and tuned logic used to optimize charging time and power distribution during; conditioning of the Tote by pulling down the temperature of an active Tote to the desired target temperature, maintaining temperature during idle state, and maintaining threshold temperature during active use.

In some embodiments, a racking system includes a Tote docking connector, power distribution cabling, extendable racking for improve access to the Tote.

In some embodiments, an electrical distribution comprising a polarity of rechargeable lithium-ion batteries sized to meet the power requirements of the polarity of thermal electric Tote, power cables sized for the power rating, power connectors, a shunt, a power distribution block with a polarity of connection points, a current and voltage monitoring system, polarity of relays, and an active thermal electric Tote.

In some embodiments, the system also includes a heating system that monitors battery temperature and provides heat to the batteries to improve proper use in cold environments.

In some embodiments, the system also includes an insulated material to trap heat during use and allow for higher ambient differentiated temperatures in the select area for the battery placement when not in use.

In some embodiments, the system also includes a heating element and fan that is placed properly in relation to the battery system and, where a current is suppled through the heating element to maintain a circulated air of a higher differential ambient temperature.

In some embodiments, the system also includes a processor and tuned logic used to optimize charging time and power distribution during; conditioning of the Tote by pulling down the temperature of an active Tote to the desired target temperature, maintaining temperature during idle state, and maintaining threshold temperature during active use.

In some embodiments, a racking system includes a Tote docking connector, power distribution cabling, and/or extendable racking for improve access to the Tote.

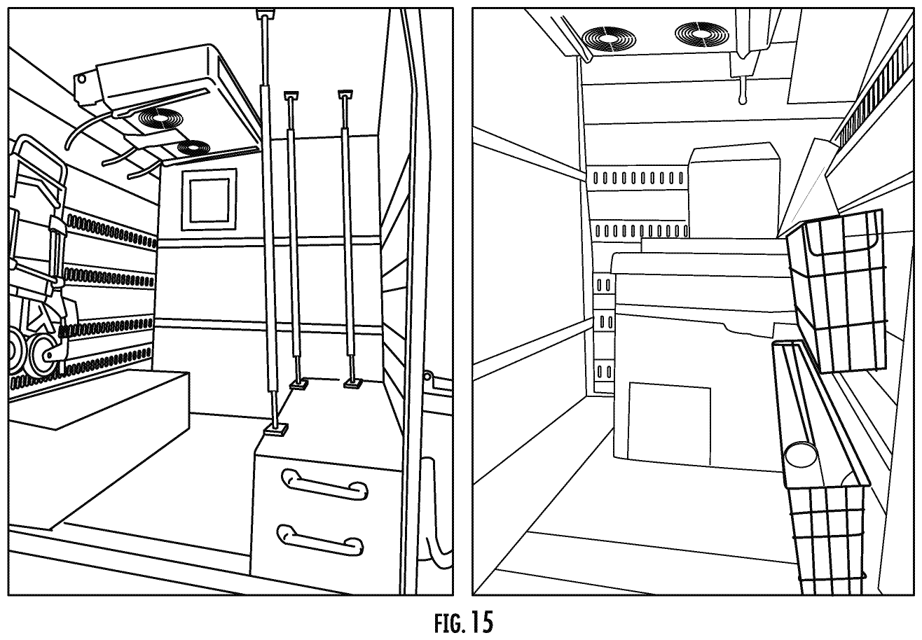

In some embodiments, there is a need to insulate the truck, penetrate the exterior, run multiple compressor systems inside and outside the truck, place support structures to hold the weight of the cooling system and bulkhead dividers to separate zones. FIG. 15 illustrates a single truck and the two zones created using traditional compressor cooling and transport processes.

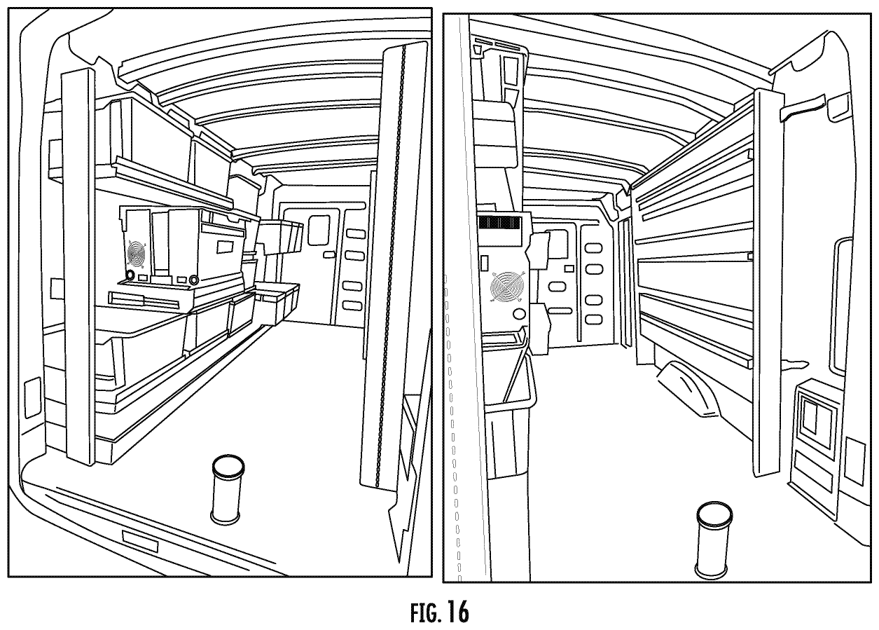

FIG. 16 illustrates an example use of the disclosed totes. Using these totes allows for muti temp cold chain transport and upfitting of electric vehicles or gas-powered vehicles.

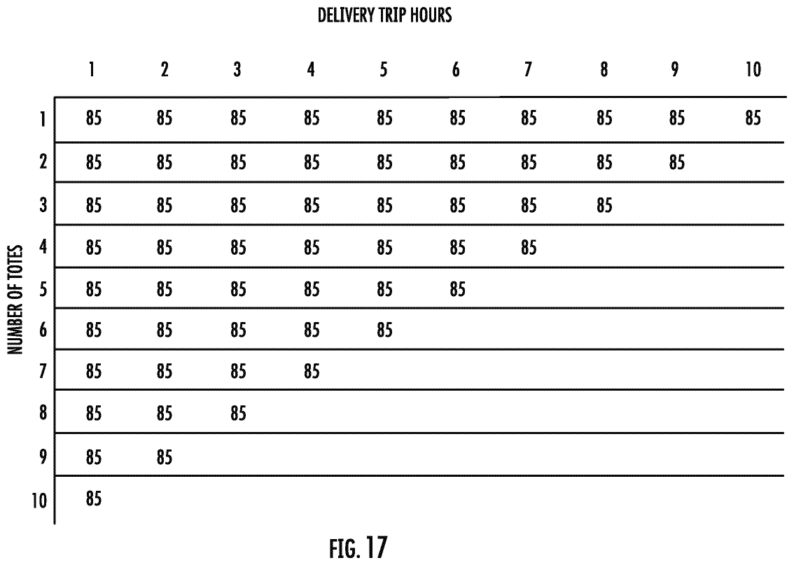

In some embodiments, an “on demand” system allows only cooling what is needed to be cooled, when cooling is needed, and at the temperature needed, all confined to actively cooled totes. By using “on demand” cooling each tote or order can be shut off after each stop, thereby saving energy and extending the range of the vehicle. An example of this can be seen in FIG. 17. This uses some assumptions such as: Per Tote SS power (W)=85 W (low power op., maintaining <10° F.); Per Tote at full power=135 W; Total Energy Usage (kW-hr)=3.9 kW; EV Truck kWh/mile*=2.0; Total Realized Range Reduction Estimate (Miles)=2.0.

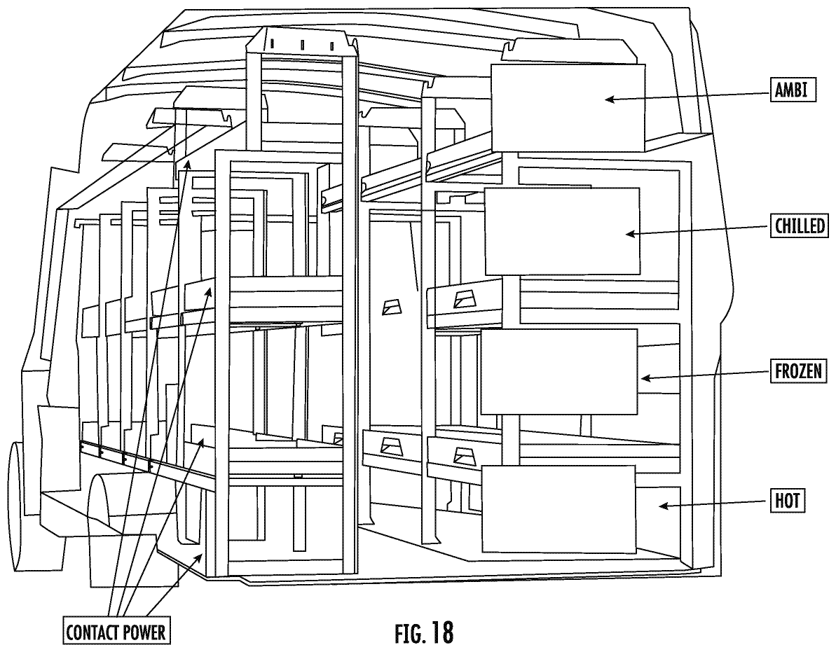

Ability to place a customer's entire order of all temperatures on one shelf or section of the truck using temp controlled totes placed on shelving that has been upfitted with contact power that powers the totes in transport or when stopped. This is illustrated in FIG. 18. Contact power can be run from a separate rechargeable battery system or off the vehicle battery system.

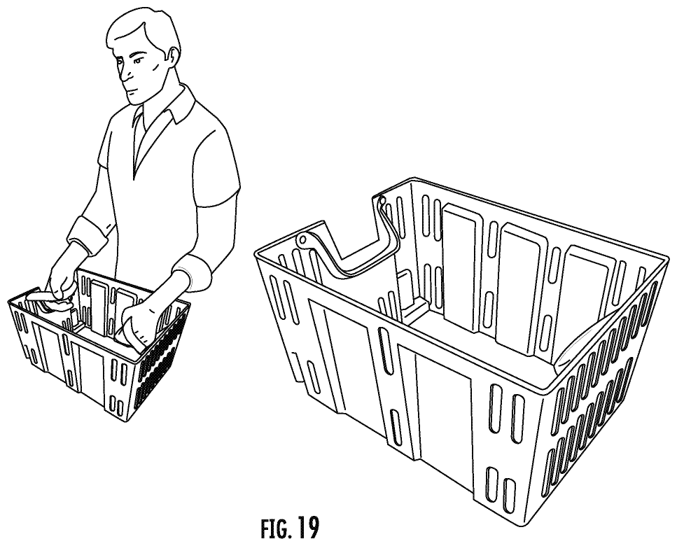

A tote liner can be placed into the tote to help transport items in and out of the van in addition to the ability to move the totes in and out of the van with each order, the liner would be used in areas that require multiple totes of orders to be delivered on a dolly or cart to areas such as office buildings or apartment buildings or when the distance from the delivery vehicle to the drop point is a long distance. An example of this is illustrated in FIG. 19.

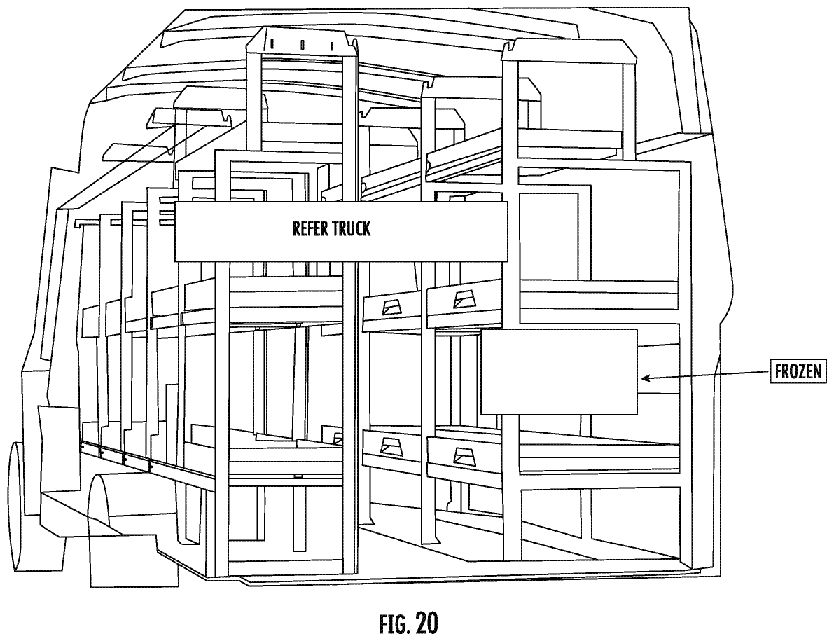

Refrigerated (Refer) trucks turned into Tri temp or multi temp trucks, with the tote you have the ability to upfit an existing refer truck to tri temp or multi temp by placing the power contacts and using the freezer tote you can run the freezer tote in chilled refer trucks without adding compressor systems, sectioning off the truck with bulk heads or dividers and keep the truck open that allows the customer to use existing assets. An example of this is illustrated in FIG. 20.

In some embodiments, the system uses water and CO₂ cooling and freezing totes. In some embodiments, portable active cooling totes that can be used to pick into, stage, load on vehicle and deliver to customers door. In some embodiments, the contact or wireless charging location for the totes in racks and shelving. In some embodiments, no penetration of the exterior of the vehicle is needed. In some embodiments, IOT is used to maintain cold chain documentation. In some embodiments, IOT is used to turn on and off totes as orders are delivered to reduce power “on-demand cooling”. In some embodiments, the ability to store any temperature required for food safety of an entire order in one section of the vehicle without separation or dividers.

In some embodiments, integrated contacts can allow for direct connection and/or stand-alone battery module to be securely docked/affixed to container for self-powered applications.

These embodiments could potentially be used in (but not limited to): Robotic warehouse/racking systems where manual plug/unplug of the container is not feasible and/or desirable; Manual systems where minimum employee interaction time is needed; Mobile delivery platforms to extend safe delivery ranges; Remote deployment dock/racks. These generic automated warehouse/racking locations could be kept at room temperature, according to some embodiments of the current disclosure.

Some embodiments feature optional security functions to enable remote, unattended, drop-off and/or pickup. A secure local/remote dock can provide access control to the tote itself, in contrast or in addition to access control of the contents of the tote, according to some embodiments of the current disclosure. In some embodiments, a rack implementation with docking/locking rails is used, according to some embodiments of the current disclosure. More details can be found in patent application PCT/US2021/054515 filed on Oct. 12, 2021, the disclosure of which is hereby incorporated herein by reference in its entirety.

Those skilled in the art will recognize improvements and modifications to the preferred embodiments of the present disclosure. All such improvements and modifications are considered within the scope of the concepts disclosed herein and the claims that follow.

1. A vehicle for transporting one or more actively cooled totes, the vehicle comprising:
a central heat reject subsystem operable to reject heat from the one or more actively cooled totes; and
an attachment mechanism for moving heat from the one or more actively cooled totes to the central heat reject subsystem.

2. The vehicle of claim 1 wherein the central heat reject subsystem comprises one or more of:
a central vent fan able to provide airflow to outside of the vehicle; and
a liquid cooling loop.

3. The vehicle of claim 1 wherein the attachment mechanism for moving the heat comprises flexible ducting.

4. The vehicle of claim 1 wherein the attachment mechanism for moving the heat comprises one or more compressible gaskets that can seal a duct to the heat reject of one of the one or more actively cooled totes.

5. The vehicle of claim 1 wherein the attachment mechanism for moving the heat comprises one or more spring-loaded mechanisms to aid the connection of the one or more actively cooled totes.

6. The vehicle of claim 1 further comprising: one or more dampers that can reduce air from moving back into the vehicle when a tote location is not occupied.

7. The vehicle of claim 1 further comprising:
a support structure operable to hold the one or more actively cooled totes;
where the attachment mechanism for moving heat from the one or more actively cooled totes to the central heat reject subsystem is integrated into the support structure.

8. The vehicle of claim 7 wherein the support structure comprises hollow channels and ducting can be through these hollow channels.

9. The vehicle of claim 1 further comprising: one or more dampers that can reduce air from moving back into the vehicle when a tote location is not occupied.

10. The vehicle of claim 1 further comprising: one or more vents to improve air inlet from outside.

11. The vehicle of claim 10 wherein the one or more vents are angled to increase an amount of air coming in as the vehicle travels faster.

12. The vehicle of claim 1 further comprising: one or more additional vents in the back of the vehicle to enhance turbulence and/or air mixing inside the vehicle.

13. The vehicle of claim 2 wherein the liquid cooling loop comprises a liquid cold plate which stays stationary in the vehicle operable to mate to the one or more actively cooled totes.

14. The vehicle of claim 2 wherein the liquid cooling loop is cooled using a radiator and/or a refrigerant chiller loop.
